(19) United States
(12) Patent Application Publication
(10) Pub. No.: US 2021/0287819 A1
(43) Pub. Date: Sep. 16, 2021

(54) COMBINATION OF CONTAINERS AND METHOD FOR ELIMINATING RADIOACTIVE SUBSTANCES

(71) Applicant: Jürgen Himbert, Püttlingen (DE)

(72) Inventor: Jürgen Himbert, Püttlingen (DE)

(21) Appl. No.: 16/326,426

(22) PCT Filed: Sep. 5, 2017
(86) PCT No.: PCT/IB2017/001086

§ 371 Date: Feb. 19, 2019

(30) Foreign Application Priority Data
Sep. 8, 2016 (DE) 10 2016 010 903.3

(51) Int. Cl. G21F 5/005; G21F 9/00; G21F 1/08; G21F 1/06; G21F 5/14; G21F 9/36

(52) U.S. Cl. CPC G21F 5/005; G21F 9/008; G21F 9/36; G21F 1/06; G21F 5/14; G21F 1/085

(57) ABSTRACT

The invention relates to a combination of containers intended to discharge radioactive substances into the earth's magma by pouring them into lava lakes, and to a method for using these containers. The radioactive substances are preferably placed in ovoid waste containers that are loaded into a transport container and discharged therewith into a lava lake. The transport container decomposes by melting following a first immersion at a given depth and releases the waste containers, which continue to move downwards.

### CROSS-REFERENCE TO RELATED APPLICATION

This application is an U.S. national phase application under 35 U.S.C. § 371 based upon co-pending International Application No. PCT/D32017/001086 filed on Sep. 5, 2017. Additionally, this U.S. national phase application claims the benefit of priority of co-pending International Application No. PCT/D32017/001086 filed on Sep. 5, 2017 and German Application No. 10 2016 010 903.3 filed on Sep. 8, 2016. The entire disclosures of the prior applications are incorporated herein by reference. The international application was published on Mar. 15, 2018 under Publication No. WO 2018/046996 A1.

### BACKGROUND

### Technical Field

The invention relates to a combination of containers and a method for the safe disposal of radioactive wastes into the Earth's magma making use of active lava lakes.

Radioactive and nuclear wastes are radioactive substances which have become unusable, or which may no longer be used because of legal requirements. Most of these substances are generated by the use of nuclear energy in nuclear power plants. A smaller portion comes from medicine and physical and natural or technical research. Other liabilities inherited from the past are of military origin. These hazardous substances are kept mostly in intermediate storage facilities. Although technical processes for packaging, transmutation or reuse have been tested for decades, the question of an absolutely safe disposal of highly radioactive wastes has remained unanswered to this day for technical and political reasons.

Packaging allows to transform these wastes into a chemically stable state, insoluble or of poor solubility in water. Preferably, they are poured into glass. But reactions were discovered capable, in the long term, to generate substances which, theoretically, can destroy the glass.

Final storage in old mines, practised, in particular, in Germany, can not necessarily guarantee safe containment of radioactive substances in the long term due to long periods of storage. Corrosion of the containers and dislocation of geological terrain and salt mines are possible.

Reuse and reprocessing of radioactive substances have been studied for decades. However, to this day, they have not led to any efficient use of radioactive wastes.

Similarly, transmutation in the course of which long-lived nuclides are transformed into short-lived nuclides in appropriate facilities, is still in its infancy.

International agreements have been able to end disposal into the sea. Similarly, at least in Western Europe, it is prohibited to store wastes outdoors. Other agreements prohibit the storage in ice or under the pack-ice of Antarctica.

For all these reasons, we have already reflected on safe methods in the past. Patent DE 31 09 640 A discloses a method wherein radioactive substances are enclosed in containers and introduced into the liquid magma of an active volcano. But it lacks the precise structural constitution of such containers and the exact technical description of the non-reversible and thus safe inflow into the magma. The same criteria are lacking in U.S. Pat. No. 4,738,564, wherein only the idea of introducing a container filled with radioactive material into active volcanos is presented. In the patent application US 2003/0130557 A1 the same idea of pouring a container filled with hazardous substances into seawater or volcanic lakes re-emerges. Only a cylindrical body made of steel with a sharp tip is shown. US patent application 2005/0047870 A1 describes a projectile-shaped container, which is discharged into the bottom of the lava flows. However, all these ideas lack accurate technical specifications for the container itself and for its safe discharge into the liquid magma of an active volcano.

It is not at all sure that the filled container will reach the magma without damage through the hardened lava blocks of the mouth of the active lava lake by way of the subduction current downwards through the Earth's crust. Sudden and unpredictable emissions of active lava from the lake which would bring the container back to the surface of the Earth have not been addressed so far. The damage mentioned above, caused by hardened blocks of lava or rock have not been considered either.

It is therefore the object of the invention to develop a container system for radioactive or hazardous substances, which ensures the safe immersion of the containers filled with these substances from a lava lake, on the surface of the Earth, into the Earth's magma.

### BRIEF SUMMARY OF THE PRESENT TECHNOLOGY

In view of the foregoing disadvantages inherent in the known devices and methods now present in the prior art, the present technology provides a novel container and method for eliminating radioactive substances, and overcomes the above-mentioned disadvantages and drawbacks of the prior art. As such, the general purpose of the present technology, which will be described subsequently in greater detail, is to provide a new and novel container and method for eliminating radioactive substances which has all the advantages of the prior art mentioned heretofore and many novel features that result in a container and method for eliminating radioactive substances which is not anticipated, rendered obvious, suggested, or even implied by the prior art, either alone or in any combination thereof.

The problem is solved by a combination of an outer container serving as a transport container or receptacle and one or a plurality of inner containers serving as waste containers. A waste container here contains radioactive substances to be disposed of and is installed on its own or with others in the transport container protected against destruction from the outside.

For the sake of simplicity, the term ‘container’ is used here indifferently for various receptacles used. It should therefore be noted that the term ‘container’ may also refer to a receptacle, notably as regards the transport receptacle, more commonly referred to as transport container.

The transport container is used to safely transport the waste container to the molten lava lake, discharging it safely into the liquid magma and to immerse it without destruction into the magma. When a certain depth is reached, at which the combination of conveying elements sinks irreversibly, the waste containers are released by melting of the transport container and continue their immersion.

The formation of a round and convex three-dimensional body in the form of a hollow ovoid provides good flow properties when immersing a waste container. The drawback however is that in the case of a waste container of this specific symmetrical shape, the ideal immersion is not guaranteed and skewing is not excluded. This may cause great difficulties when the magma channel has a narrow passage. To avoid this, the physical centre of gravity of the loaded container is placed in one half, which ensures a vertical position during immersion. An advantageous shape of the container is that of an elongate chicken egg. The vertical drop position is given just by the larger envelope in one half, and thus by the higher weight. This advantageous position of the empty ovoid container should not, however, be negated by improper loading which would work against it.

The outer wall of the transport container consists of several shells. The inner shell is made of a metal or metal alloy having a melting point higher than that of molten lava. Here, preference is given to tungsten steel. This inner shell is coated on its outside with a ceramic layer resistant to shocks and difficult to destroy in order to avoid damage by hardened lava plates or blocks of rock of the Earth's crust and upper reaches of the lava lake. The waste container is preferably composed of two-part halves which are sealed after filling with the radioactive charge so as to be gastight and resistant to mechanical damage. Preference is given here to a threaded connection on the edges of both halves by means of which they can be screwed together. Additional laser welding on the contact points provides even more safety. The radioactive substances are packed into the elementary tungsten container in the cast-iron perforated individual containers, so that no critical nuclear reaction can occur. The screw connections prevent waste from escaping.

The ovoid containers and those containing radioactive substances are transported in a special transport container to be conveyed to the lava lakes and discharged into the molten lava lake. This container must have mechanical stability at temperatures up to 1400° C. and must melt at the earliest at a depth of about three thousand metres. The transport container is, for instance, itself made of metal, and clad by ceramic parts. It is also provided with a fastening ring and devices for discharge into the lava lake by using cranes. The proposed material is brass. After slow immersion into the molten lava, this ring and the connection systems to the crane melt. Once the depth is attained at which the immersion is no longer reversible, the transport container itself melts as well, thereby releasing the waste container(s) which continue to sink.

According to one aspect of the present technology, the present technology essentially includes a container system for disposal of radioactive substances. The container system can include at least one waste container, and a transport container. The waste container can include an inner shell consisting of a material having a melting point greater than molten lava, the inner shell being configured to receive a radioactive substance, and an outer shell coating an exterior surface of said inner shell. The transport container can be configured to store therein the waste container.

According to another aspect of the present technology, a method for using a container system for disposal of radioactive substances into magma of lava lakes can be utilized. The method can include introducing a radioactive substance into a plurality of ovoid waste containers each including an inner shell made of tungsten steel and an outer shell made of ceramic material. Introducing the waste containers into a metal transport container that is cladded with ceramic material, while the transport container contains the waste containers. Immersing the transport container in a lava lake by a crane system so that the transport container melts after immersion at a depth of three thousand meters so that the waste containers are released upon melting of the transport container and continue to sink into the lava lake.

In some embodiments of the present technology, the inner shell can consist of two halves which are assembled after filling with the radioactive substance.

Some embodiments of the present technology can include a plurality of perforated individual containers each configured to receive radioactive substance, and wherein the inner shell includes a support wall configured to support each of the individual containers.

In some embodiments of the present technology, the individual containers are each made of cast-iron.

In some embodiments, the two halves can each include a contact edge provided with threading configured to assemble the two halves of the inner shell together. The two halves of the inner shell can be assembled and the outer shell can coat the assembled inner shell resulting in the waste container being sealed.

In some embodiments, the inner shell is made of tungsten steel.

In some embodiments, the outer shell is made of a ceramic material.

In some embodiments, an outer shape of the sealed waste container is a hollow ovoid.

In some embodiments, an outer shape of the sealed waste container is a spindle-shaped.

In some embodiments, an outer shape of the sealed waste container is oblong.

In some embodiments, the sealed waste container can be a plurality of sealed waste containers, and the transport container can be configured to store therein the plurality of sealed waste containers.

In some embodiments, the sealed waste container can have a center of gravity situated in one of the two halves so that it assumes a vertical position when in a lava stream.

In some embodiments, the transport container can consist of a material which melts at an earliest at a depth of more than three thousand meters underground.

Some embodiments of the transport container can be coated with a ceramic layer.

In some embodiments, the transport container and the ceramic layer is surrounded by a brass ring.

Some embodiments of the transport container can include a hook configured for lifting or lowering the transport container.

These together with other objects of the present technology, along with the various features of novelty that characterize the present technology, are pointed out with particularity in the claims annexed to and forming a part of this disclosure. For a better understanding of the present technology, its operating advantages and the specific objects attained by its uses, reference should be made to the accompanying drawings and descriptive matter in which there are illustrated embodiments of the present technology.

### BRIEF DESCRIPTION OF THE DRAWINGS

The characteristics and advantages of the present invention are illustrated by the following description of an exemplary embodiment and with reference to the drawings.

There is shown in:

FIG. 1 is a partial cross-sectional perspective view of the principle of construction of a sealed waste container.

FIG. 2 is an exploded perspective view of the two separate and loaded halves of a waste container.

FIG. 3 is a perspective view the principle of construction of a transport container.

### DETAILED DESCRIPTION OF THE PREFERRED EMBODIMENTS

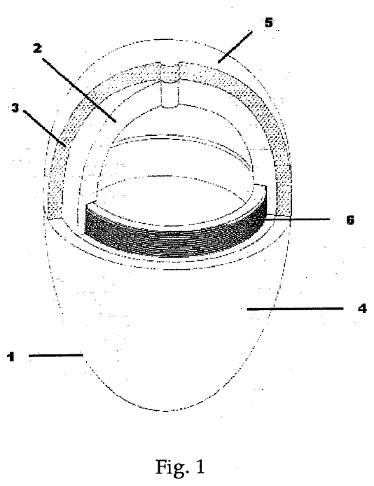

FIG. 1 schematically shows an ovoid transport container 1. The latter consists of two shells, namely an inner wall 2 made of tungsten steel, and an outer wall 3 consisting of ceramics or ceramic components.

The inner shell 2 is made of a metal or metal alloy having a melting point higher than that of molten lava. Here, preference is given to tungsten steel. This inner shell 2 is coated on its outside with the outer shell 3 including a ceramic layer resistant to shocks and difficult to destroy in order to avoid damage by hardened lava plates or blocks of rock of the Earth's crust and upper reaches of the lava lake.

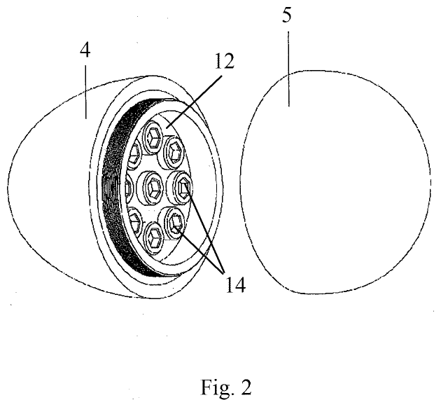

FIG. 2 shows the open waste container, consisting of two halves, namely the lower ovoid shape 4 and the upper ovoid shape 5. In addition to their screw connection, these two halves each have on their edge a thin threading 6 which connects them after filling and which is sealed even more tightly by laser treatment.

The waste container is preferably composed of the two-part halves 4, 5 that are sealed after filling with the radioactive charge so as to be gastight and resistant to mechanical damage. Preference is given here to a threaded connection 6 on the edges of both halves 4, 5 by means of which they can be screwed together. Additional laser welding on the contact points provides even more safety. The radioactive substances are packed into the elementary tungsten container by way of a plurality of cast-iron perforated individual containers 14, so that no critical nuclear reaction can occur. The individual containers 14 are supported inside one of the two-part halves 4, 5 by way of a support wall 12. The screw connections prevent waste from escaping.

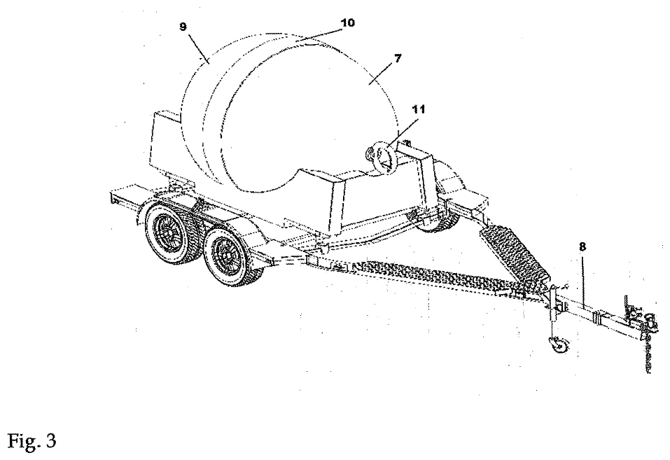

FIG. 3 illustrates the principle of mounting a transport container 7 on a transport vehicle 8. It is coated with a ceramic layer 9 and provided with a fastening ring 10. On one end, it has a hook 11 by which it is raised up and into the lava lake by means of a crane.

The ovoid containers and those containing radioactive substances are transported in the special transport container 7 to be conveyed to the lava lakes and discharged into the molten lava lake. This container 7 can have mechanical stability at temperatures up to 1400° C. and can melt at the earliest at a depth of about three thousand metres. The transport container is, for instance, itself made of metal, and clad by ceramic parts. It is also provided with a fastening ring 10 and devices for discharge into the lava lake by using cranes. The proposed material is brass. After slow immersion into the molten lava, this ring 10 and the connection systems to the crane melt. Once the depth is attained at which the immersion is no longer reversible, the transport container 7 itself melts as well, thereby releasing the waste container(s) 1 which continue to sink.

While embodiments of the container and method for eliminating radioactive substances have been described in detail, it should be apparent that modifications and variations thereto are possible, all of which fall within the true spirit and scope of the present technology. With respect to the above description then, it is to be realized that the optimum dimensional relationships for the parts of the present technology, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present technology. For example, any suitable sturdy material may be used instead of the above-described.

Therefore, the foregoing is considered as illustrative only of the principles of the present technology. Further, since numerous modifications and changes will readily occur to those skilled in the art, it is not desired to limit the present technology to the exact construction and operation shown and described, and accordingly, all suitable modifications and equivalents may be resorted to, falling within the scope of the present technology.

1-13. (canceled)

14. A container system for disposal of radioactive substances in magma, said container system comprising:
at least one waste container comprising:
an inner shell consisting of a material having a melting point greater than molten lava, said inner shell being configured to receive a radioactive substance; and
an outer shell coating an exterior surface of said inner shell; and
a transport container configured to store therein said waste container.

15. The container system of claim 14, wherein said inner shell consists of two halves, which are assembled after filling with the radioactive substance.

16. The container system of claim 15 further comprising a plurality of perforated individual containers each configured to receive radioactive substance, and wherein one of said two halves of said inner shell includes a support wall configured to support each of said individual containers.

17. The container system of claim 16, wherein said individual containers are each made of cast-iron.

18. The container system of claim 17, wherein said two halves each include a contact edge provided with threading configured to assemble said two halves of said inner shell together, wherein said two halves of said inner shell are assembled and said outer shell coats said assembled inner shell resulting in said waste container being sealed.

19. The container system of claim 18, wherein said inner shell is made of tungsten steel.

20. The container system of claim 18, wherein said outer shell is made of a ceramic material.

21. The container system of claim 18, wherein an outer shape of said sealed waste container is a hollow ovoid.

22. The container system of claim 18, wherein an outer shape of said sealed waste container is a spindle-shaped.

23. The container system of claim 18, wherein an outer shape of said sealed waste container is oblong.

24. The container system of claim 18, wherein said sealed waste container is a plurality of sealed waste containers, and said transport container is configured to store therein said plurality of sealed waste containers.

25. The container system of claim 18, wherein said sealed waste container has a center of gravity situated in one of said two halves so that it assumes a vertical position when in a lava stream.

26. The container system of claim 18, wherein said transport container consists of a material which melts at an earliest at a depth of more than three thousand meters underground.

27. The container system of claim 18, wherein said transport container is coated with a ceramic layer.

28. The container system of claim 27, wherein said transport container and said ceramic layer is surrounded by a brass ring.

29. The container system of claim 28, wherein said transport container includes a hook configured for lifting or lowering said transport container.

30. A method for using a container system for disposal of radioactive substances into magma of lava lakes, said method comprising the steps of:
a) introducing a radioactive substance into a plurality of ovoid waste containers each including an inner shell made of tungsten steel and an outer shell made of ceramic material;
b) introducing said waste containers into a metal transport container that is cladded with ceramic material, while said transport container containing said waste containers; and
c) immersing said transport container in magma of a lava lake by a crane system so that said transport container melts after immersion at a depth of three thousand meters so that said waste containers are released upon melting of said transport container and continue to sink into the lava lake.
